(19) United States
(12) Patent Application Publication
(10) Pub. No.: US 2026/0055644 A1
(43) Pub. Date: Feb. 26, 2026

(54) DOOR LATCH

(71) Applicant: Minebea AccessSolutions France, Alfortville (FR)

(72) Inventors: Jean-Marc VERBRUGGHE, Alfortville (FR); François DEBROUCKE, Alfortville (FR); Laurent DURIEZ, Alfortville (FR)

(73) Assignee: Minebea AccessSolutions France, Alfortville (FR)

(21) Appl. No.: 19/306,299

(22) Filed: Aug. 21, 2025

(30) Foreign Application Priority Data
Aug. 22, 2024 (EP) 24315386
Aug. 22, 2024 (EP) 24315387

(51) Int. Cl. E05B 81/14; E05B 81/06; E05B 81/30; E05B 81/34; E05B 81/46

(52) U.S. Cl. CPC E05B 81/14; E05B 81/06; E05B 81/30; E05B 81/34; E05B 81/46

(57) ABSTRACT

A door latch for closing a door of a vehicle, such as a motor vehicle, includes a retention unit, an electrical gear wheel, an inner release lever, a central opening lever being driven in active position by the movement of the inner release lever or by the electrical gear wheel, an outer release lever, and a locking lever. The locking lever can be moved from the locked position to the unlocked position by the movement of the central opening lever driven in movement by the inner release lever from the rest position to the active position and by the movement of the electrical gear wheel from the rest position to the active position. The locking lever remains in the unlocked position after a releasing of the door latch.

### TECHNICAL FIELD

The present invention relates to a door latch, such as a side door or a trunk lid, in particular for vehicles, such as motor vehicle.

### BACKGROUND OF THE INVENTION

Conventional door latches have a release system which is purely mechanical. End user directly activates a mechanical opening control that moves a cable which release a door latch of the door enabling the door to open. There are usually two mechanical opening controls on the door, an inside and an outside handle. In the event of a power failure, these two mechanical opening controls can still be used.

Nowadays, door latches comprise an electrical release mechanism, also called E-release mechanism, which enables to open the door by a simple pressure on a switch or a movement in front of a detector.

These door latches can be locked and unlocked electrically. The locking function prevents the entrance into the vehicle from the outside.

On inner mechanical release kinematic, there is a function named override which allows mechanically unlocking the door latch from inside the vehicle, by pulling the inside handle. The door latch is unlocked when a user activates the inside handle without having to first unlock the door latch electrically. This unlocking function can be done in one motion: the door latch is unlocked while the door latch is released in one same motion or the unlocking function can be done in two motions: the door latch is unlocked while the inside handle is first pulled by the user, the door latch being then released while the inside handle is pulled a second time by the user.

However, after the user has electrically opened the door latch by e-release, the door latch remains in locked position. Therefore, if a user gets out the vehicle by e-release, he can be locked out.

### SUMMARY OF THE INVENTION

The purpose of the invention is to provide a door latch which resolve at least partially the prior art drawbacks.

Thus, the present invention refers to a door latch for closing a door of a vehicle, such as a motor vehicle, comprising:
a retention unit comprising a claw and a pawl, the retention unit engaging with a striker of the vehicle in the closed position and release the striker to release the door latch in the open position,
an electrical gear wheel that is configured to be moved by a releasing motor from a rest position to an active position, an inner release lever that is configured to be moved by an inner mechanical opening control from a rest position to an active position,
a central opening lever that is configured to be moved between a rest position and an active position, the central opening lever being driven in active position by the movement of the inner release lever from the rest position to the active position or by the electrical gear wheel from the rest position to the active position,
an outer release lever that is configured to be moved by an outer mechanical opening control from a rest position to an active position,
a locking lever that is configured to move between an unlocked position in which the movement of the outer release lever releases the retention unit of the door latch and a locked position in which the locking lever disengages the outer release lever from the retention unit,

wherein the locking lever is configured to be moved from the locked position to the unlocked position by the movement of the central opening lever driven in movement by the inner release lever from the rest position to the active position, and by the movement of the electrical gear wheel from the rest position to the active position, the locking lever remaining in the unlocked position after a releasing of the door latch.

Thus, the door latch can be unlocked by the rotation of the inner release lever intending to disengage the pawl from the claw, i.e. by the user activating the inner mechanical control from inside the vehicle, and by the rotation of the electrical gear wheel intending to disengage the pawl from the claw, i.e. by the user activating an electrical opening control.

The door latch thus comprises a mechanical kinematic chain transmitting the mechanical override function (unlocking the door latch) whatever is the origin of the release, mechanical from the inner side of the vehicle or electrical. Mechanical and electrical release kinematics work thus in parallel and are synchronized. If an electric unlock is done, the mechanical kinematic is unlocked too and in the other way, if a mechanical unlock from the inside of the vehicle is done, the electric kinematic is unlocked too. The user is therefore ensured to not be locked in and to not be locked out after inner mechanical opening and electrical opening.

The door latch can also comprise one or more of the features which are described hereinbelow, taken alone or in combination.

According to an embodiment, the door latch comprises an override lever configured to move the locking lever from the locked position to the unlocked position and configured to be driven in movement by the central opening lever from the rest position to the active position. As example, the override lever is articulated to the locking lever.

According to a first embodiment, the inner release lever, the central opening lever and the electrical gear wheel are pivotally mounted on a same axis of the door latch. As example, the inner release lever and the central opening lever have a respective end which protrudes axially so that the end of the central opening lever is on the path of the end of the inner release lever in the direction of movement of the inner release lever to the active position.

According to a second embodiment, the inner release lever pivots around an axis that goes through the central opening lever.

As example, the central opening lever has a lug that is moveable in a hole of the inner release lever, the lug of the central opening lever abutting a side of the hole to be driven in movement by the inner release lever when the inner release lever is driven in movement to its active position, the lug of the central opening lever moving in the hole when the central opening lever is driven in rotation by the electrical wheel gear.

According to an embodiment, the door latch comprises a driver comprising a first lever configured to move the pawl in the open position, a second lever driven by the movement of the outer release lever and a paddle clutch configured to be moved by the locking lever in a deployed position between the first lever and the second lever of the driver such that, in the unlocked position of the locking lever, the movement of the second lever towards the active position drives the moving of the first lever to move the pawl in the open position to release the door latch and to be moved by the locking lever in a retracted position disengaging the paddle clutch from between the first lever and the second lever in the locked position of the locking lever.

According to a first embodiment, the first lever is configured to be driven by the movement of the central opening lever. The paddle clutch may then be configured to be driven in movement by the locking lever in the deployed position while the central opening lever is driving the first lever such that the door latch is unlocked and released in the same movement of the central opening lever.

According to a second embodiment, the second lever is configured to be driven by the movement of the central opening lever. The paddle clutch may then be configured to be driven in movement by the locking lever in the deployed position after the second lever has been moved by the central opening lever in a blocking position in which the second lever blocks the movement of the paddle clutch such that the paddle clutch subjected to an elastic return force moves in the deployed position once the central opening lever is released.

The door latch may comprise a locking motor configured to move the locking lever from the unlocked position to the locked position.

The locking motor may be configured to be moved in the unlocked position with the movement of the locking lever from the locked position to the unlocked position.

The invention also refers to a vehicle door comprising an inner mechanical opening control and an outer mechanical opening control wherein it comprises a door latch as describes previously; the inner mechanical opening being mechanically linked to the inner release lever and the outer mechanical opening control being mechanically linked to the outer release lever.

The invention will be better understood in view of the following description, referring to the annexed figures in which:

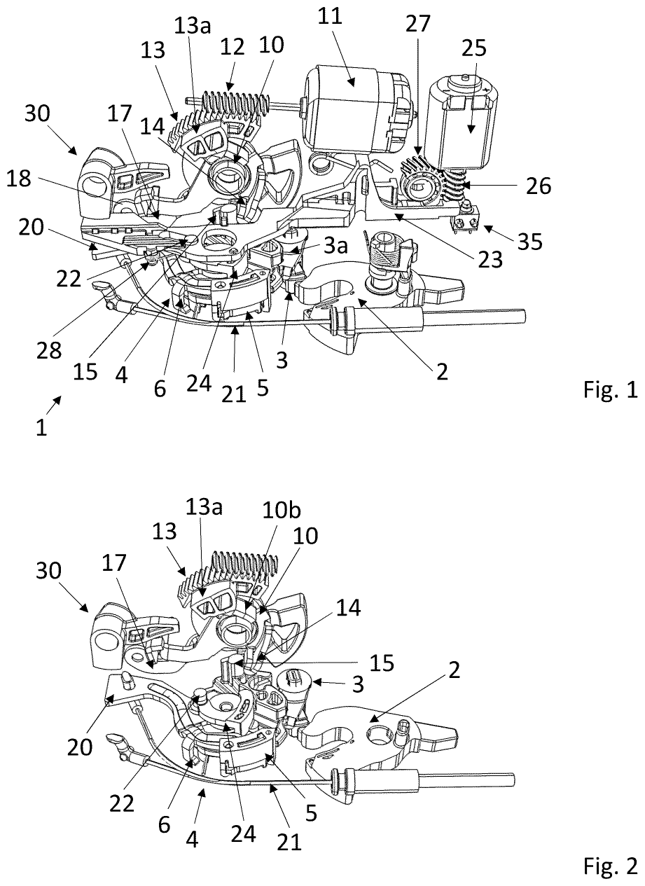

FIG. 1 is a perspective view of some element of a door latch according to a first example in a closed and locked position.

FIG. 2 is a perspective view of some elements of the door latch of FIG. 1.

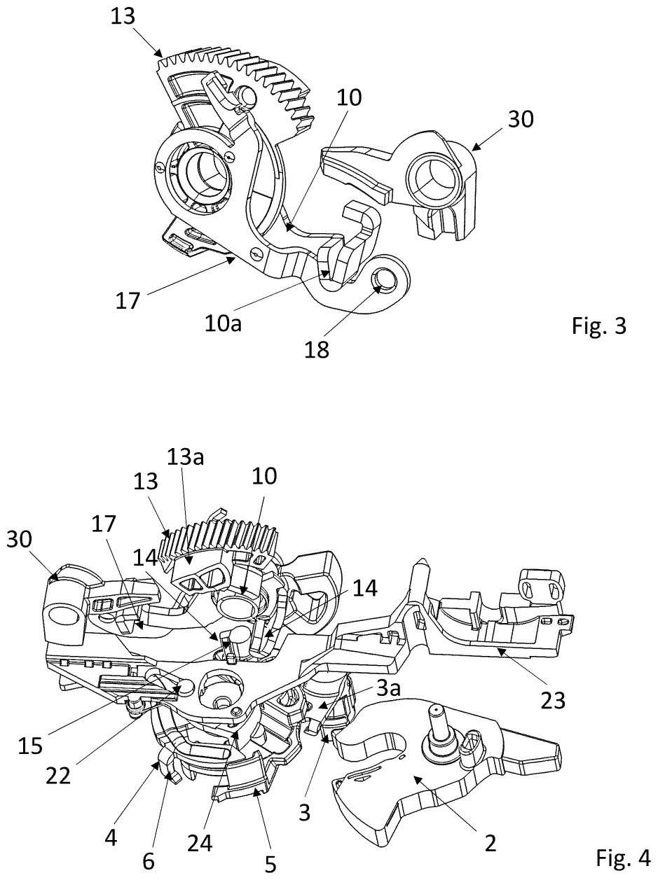

FIG. 3 is a perspective view of an inner release lever, a central opening lever, an electrical gear wheel, and an override lever of the door latch of FIG. 2.

FIG. 4 is a perspective view of some elements of the door latch of FIG. 1.

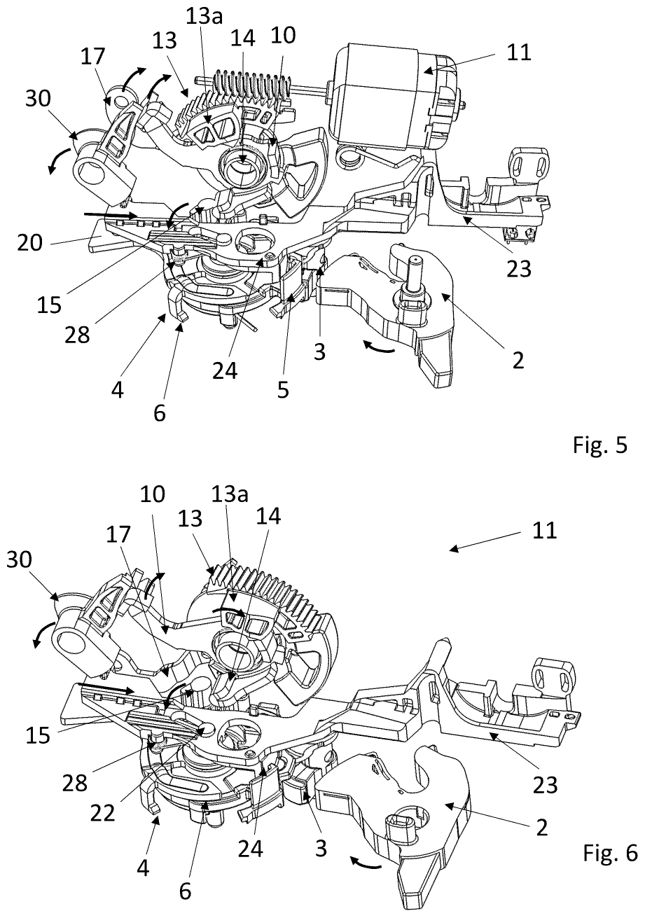

FIG. 5 is a similar view of FIG. 4, the door latch being released and unlocked during an inner opening mechanical release.

FIG. 6 is a similar view of FIG. 4, the door latch being released and unlocked during an electrical release.

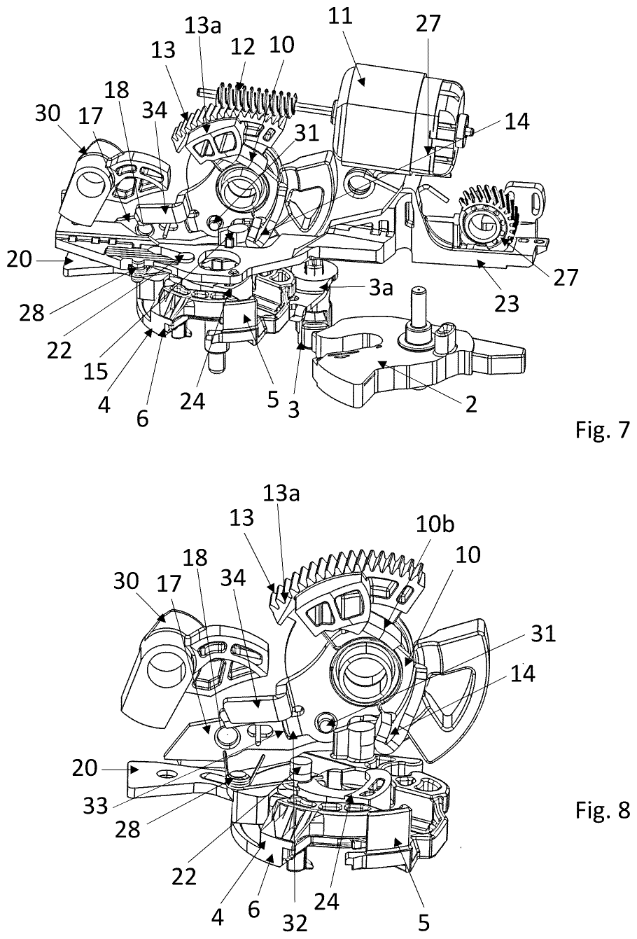

FIG. 7 is a perspective view of some elements of a door latch according to a second example, in a closed and locked position.

FIG. 8 is a perspective view of an inner release lever, a central opening lever, an electrical gear wheel, an override lever and a driver of the door latch of FIG. 7.

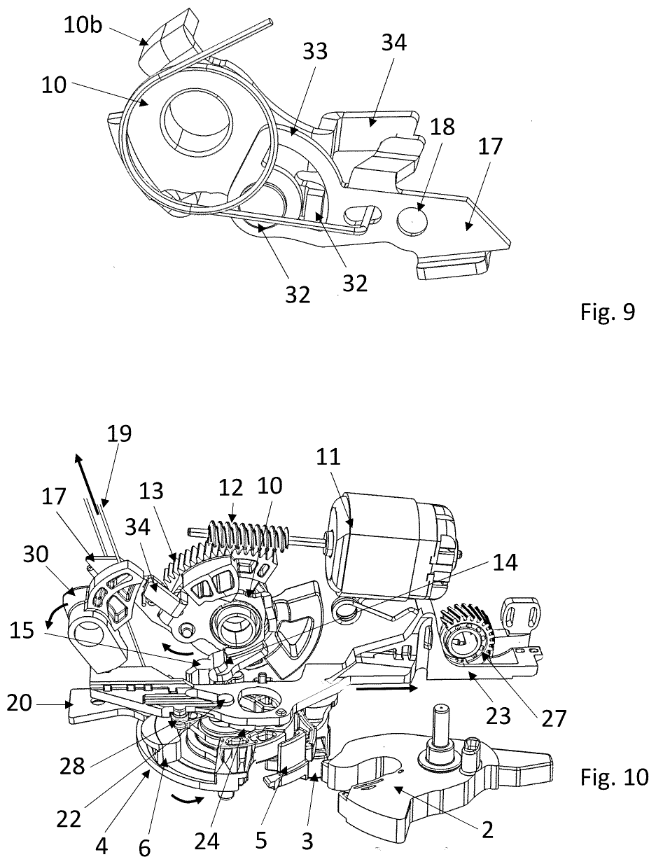

FIG. 9 is a perspective view of the inner release lever and the central opening lever (in returned position) of the door latch of FIG. 8.

FIG. 10 is a perspective view of some elements of the door latch of FIG. 7, the door latch being unlocked during a first inner opening mechanical release.

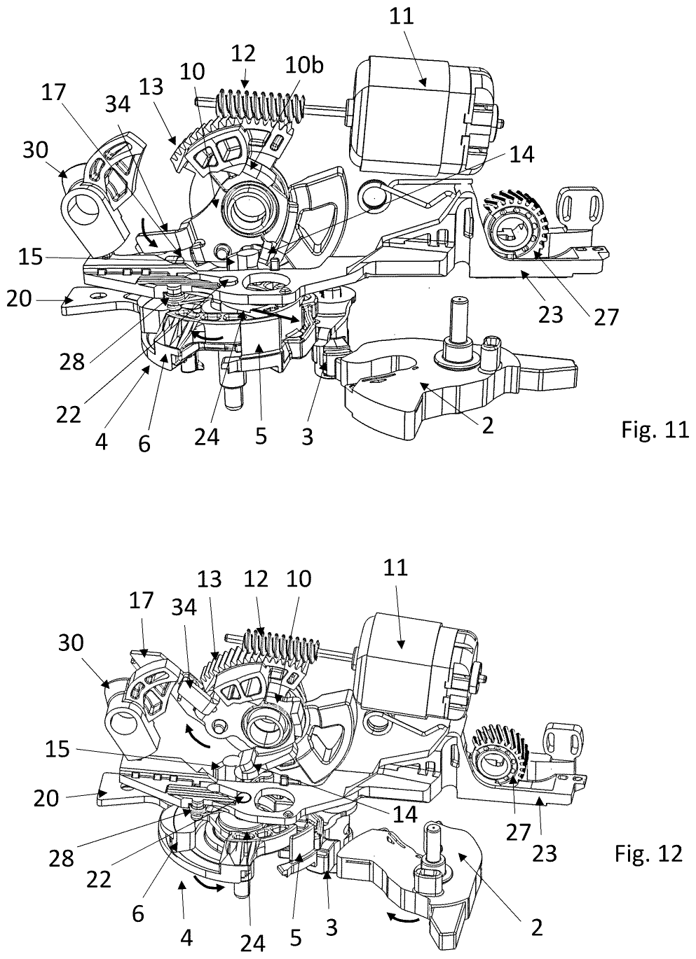

FIG. 11 is a perspective view of the door latch of FIG. 10 in the unlocked position, after the first inner opening mechanical release.

FIG. 12 is a similar view of the door latch of FIG. 11, the door latch being released during a second inner opening mechanical release.

In these figures, identical or similar elements bear the same reference numerals. Only the elements necessary for understanding the invention are shown.

### DETAILED DESCRIPTION OF THE INVENTION

The following achievements are examples. Although the specification refers to one or several embodiments, it does not imply that each reference refers to the same embodiment or that the features apply only to a single embodiment. Simple features of different embodiments can also be combined to provide other embodiments.

FIGS. 1 to 6 show a first embodiment of a door latch 1, for closing a door of a vehicle, such as a motor vehicle, in particularly a side door or a trunk lid.

The door latch 1 comprises a retention unit that comprises a claw 2 and a pawl 3.

The claw 2 and the pawl 3 are both configured to pivot between an open position (FIGS. 5 and 6) and a closed position (FIGS. 1, 2 and 4). In the closed position, the retention unit engages with a striker (not represented) of the vehicle, the striker being trapped in the claw 2 and the pawl 3 preventing the rotation of the claw 2. In the open position, the retention unit releases the striker to release the door latch 1, the pawl 3 allowing the rotation of the claw 2 and the rotation of the claw 2 releasing the striker so the door can be opened.

The pawl 3 may be subjected to an elastic return force which pushes it toward the claw 2. The claw 2 may be subjected to an elastic return force which pushes it in the open position.

The door latch 1 comprises an electrical gear wheel 13 that is configured to be moved by a releasing motor 11 of the door latch 1, thus electrically, from a rest position (FIG. 1) to an active position (FIG. 6).

More precisely here, the releasing motor 11 has an output shaft 12 having an endless screw configured to rotate the electrical gear wheel 13. The electrical gear wheel 13 may comprise teeth only on a portion of circle which depends on the angular difference between the rest position and the active position of the electrical gear wheel 13.

The releasing motor 11 is activated by a control unit of the door latch 1 when a user activates an electrical (or electronical) opening control, such as a switch of a door or a key, or a movement in front of a detector. According to an embodiment, the releasing motor 11 is a reversible motor (the output shaft 12 of the release motor 11 can be rotated in a clockwise or a counterclockwise direction).

The door latch 1 also comprises an inner release lever 17 that can be moved by an inner mechanical opening control of the vehicle door, such as an inside handle, from the inside of the vehicle, from a rest position (FIG. 1) to an active position (FIG. 5). The inner release lever 17 is mechanically linked to the inner mechanical opening control for example by a cable 19 (see FIG. 10 for the second embodiment) for example secured to the hole 18. This cable 19 can be pulled by a user activating the inner mechanical opening control.

The inner release lever 17 may be a pivoting lever. The inner release lever 17 may be subjected to an elastic return force which pushes it in the rest position.

The door latch 1 comprises a central opening lever 10 that can move between an active position (FIGS. 5 and 6) and a rest position (FIG. 1).

The central opening lever 10 is driven in active position by the movement of the inner release lever 17 from its rest position to its active position or by the electrical gear wheel 13 from its rest position to its active position.

The central opening lever 10 may be a pivoting lever. The central opening lever 10 may be subjected to an elastic return force which pushes it in the rest position.

According to an embodiment, the movement of the central opening lever 10 from the rest position to the active position moves a first lever 5 of a driver 4 of the door latch 1 which is configured to move the pawl 3 (more precisely a lever 3a of the pawl 3) in the open position to release the door latch 1.

The first lever 5 may be a pivoting lever. The first lever 5 is configured to move between a rest position and an active position. The first lever 5 may be subjected to an elastic return force which pushes it in rest position.

To rotate the first lever 5 of the driver 4, the central opening lever 10 has for example a tab 14 that cooperates with a pin 15 of the first lever 5 of the driver 4. Thus, when the central opening lever 10 rotates, the tab 14 pushes the pin 15, rotating the first lever 5.

The door latch 1 also comprises an outer release lever 20 that can be moved by an outer mechanical opening control of the vehicle door, such as an outside handle, from the outside of the vehicle, from a rest position to an active position. The outer release lever 20 is mechanically linked to the outer mechanical opening control for example by a cable 21 that can be pulled by a user activating the outer mechanical opening control (FIG. 2).

The outer release lever 20 may be a pivoting lever. The outer release lever 20 may be subjected to an elastic return force which pushes it in the rest position.

As example, the movement of the outer release lever 20 from the rest position to the active position moves a second lever 6 of the driver 4.

The second lever 6 may be a pivoting lever. The second lever 6 is configured to move between a rest position and an active position. The first lever 6 may be subjected to an elastic return force which pushes it in rest position.

The first and second lever 5, 6 of the driver 4 may have the same axis (coaxial).

The door latch 1 can be locked. The locking function prevents entrance into the vehicle from outside. For that, the door latch 1 comprises a locking lever 23 than can move between a locked position (FIG. 1) and an unlocked position (FIGS. 5 and 6).

The locking lever 23 may be configured to move in translation.

In the unlocked position (FIGS. 5 to 6), the movement of the outer release lever 20 releases the retention unit of the door latch 1, enabling the door to open and in the locked position, the locking lever 23 disengages the outer release lever 20 from the retention unit.

More precisely as example, the driver 4 comprises a paddle clutch 24 configured to be moved by the locking lever 23 in a deployed position in the unlocked position of the locking lever 23 (FIGS. 5 and 6) and to be moved by the locking lever 23 in a retracted position in the locked position of the locking lever 23 (FIG. 1).

The paddle clutch 24 may be subjected to an elastic return force which pushes it in the deployed position, for example via spring 28 which one end is linked to the paddle clutch 24 and the other end is linked to the first lever 5.

According to an embodiment, the paddle clutch 24 is configured to slide in a slot of the first lever 5 between the retracted position and the deployed position (FIGS. 1 and 2).

In the deployed position, the paddle clutch 24 is deployed between the first lever 5 and the second lever 6 of the driver 4 such that the movement of the second lever 6 towards the active position drives the moving of the first lever 5 to move the pawl 3 in the open position to release the door latch 1.

In a retracted position, the paddle clutch 24 is disengaged from between the first lever 5 and the second lever 6 (FIGS. 5 and 6) so that the movement of the second lever 6 towards the active position does not lead to a movement of the first lever 5. The door latch 1 is thus not released.

According to an embodiment, to move the paddle clutch 24, the locking lever 23 is configured to drive an axial pin 22 of the paddle clutch 24 by a hole of the locking lever 23, the locking lever 23's hole movement driving the moving of the axial pin 22 of the paddle clutch 24 and thus, the paddle clutch 24.

Thus, the moving of the first lever 5 can be driven by the movement of the central opening lever 10 from the rest position to the active position or by the second lever 6 driven by the outer release lever 20 from the rest position to the active position in the unlocked position of the locking lever 23.

In the closed and locked position (FIG. 1), the outer release lever 20 cannot release the door latch 1. The second lever 6 can be driven in rotation by the outer release lever 20 moving from its rest position to its active position but to face radially the paddle clutch 24, and thus without driving in rotation the paddle clutch 24, and thus, without driving the first lever 5, and without releasing the door latch 1. When the paddle clutch 24 is in retracted position, a gap is formed between the first lever 5 and the second lever 6 so that the second lever 6 can rotates towards the active position within the gap without interaction with the first lever 5. The first lever 5 remains therefore in the rest position.

The locking lever 23 is configured to be moved from the locked position to the unlocked position by the movement of the central opening lever 10 driven in movement by the inner release lever 17 from the rest position to the active position and by the movement of the electrical gear wheel 13 from the rest position to the active position, the locking lever 23 remaining in the unlocked position after a releasing of the door latch 1. The locking lever 23 remains in the unlocked position after a releasing of the door latch 1, whatever the releasing has been initiated mechanically by the activation of the inner mechanical control or electrically by the activation of the electrical opening control.

According to an embodiment, the electrical gear wheel 13 and the central opening lever 10 are coaxial. They have a respective end 13a, 10b which protrudes axially so the end 10b of the central opening lever 10 is on the path of the end 13a of the electrical gear wheel 13 in the direction of movement of the electrical gear wheel 13 to the active position (FIG. 2). Thus, the electrical gear wheel 13 and the central opening lever 10 turn together when the electrical gear wheel 13 is driven to the active position.

The end 13a of the electrical gear wheel 13 is out of the path of the central opening lever 10 when the central opening lever 10 is driven to its active position by the inner release lever 17 so that the electrical gear wheel 13 is not driven in motion (or not significantly).

In this first example, the inner release lever 17, the central opening lever 10 and the electrical gear wheel 13 are coaxial. The inner release lever 17, the central opening lever 10 and the electrical gear wheel 13 are pivotally mounted on a same axis of the door latch 1. The electrical gear wheel 13 may be axially interposed between the inner release lever 17 and the central opening lever 10.

According to an embodiment, the inner release lever 17 and the central opening lever have a respective end 17a, 10a which protrudes axially so that the end 10a of the central opening lever 10 is on the path of the end 17a of the inner release lever 17 in the direction of movement of the inner release lever 17 to the active position (FIG. 3). Thus, the inner release lever 17 and the central opening lever 10 turn together when the inner release lever 17 is driven to the active position.

The end 17a of the inner release lever 17 is out of the path of the central opening lever 10 when the central opening lever 10 is driven to its active position by the electrical gear wheel 13 so that the inner release lever 17 is not driven in motion (or not significantly).

The door latch 1 may comprise a locking motor 25 configured to move the locking lever 23 from the unlocked position to the locked position, for example with the next locking request of the user.

The locking motor 25 has here an output shaft 26 having an endless screw configured to rotate a locking pinion 27. As an example, the locking pinion 27 has a rib on one of its faces which is configured to cooperate with the locking lever 23 to move the locking lever 23 in the locked position when the locking pinion 27 is rotated by the output shaft 26 of the locking motor (translation to the left on the drawings).

The locking motor 25 is configured to be moved from the locked position to the unlocked position with the movement of the locking lever 23 from the locked position to the unlocked position.

According to an embodiment, the locking motor 25 is a reversible motor (the output shaft 26 of the locking motor 25 can be rotated in a clockwise or a counterclockwise direction). The movement of the locking lever 23 from the locked position to the unlocked position (translation to the right on the drawings) drives the rotation of the locking pinion 27 in opposite direction and thus the locking motor 25 in opposite direction.

According to an embodiment, the door latch 1 comprise an override lever 30 that is configured to move the locking lever 23 from the locked position to the unlocked position. The override lever 30 is configured to be driven in movement by the central opening lever 10 from the rest position to the active position, intended to release the striker from the retention unit to release the door latch 1.

The override lever 30 may be a pivoting lever.

In this example, the override lever 30 is articulated to the locking lever 23.

The override lever 30 remains in the unlocked position after a releasing of the door latch 1, such that the locking lever 23 remains in the unlocked position after a releasing of the door latch 1 whatever the releasing has been initiated mechanically by the activation of the inner mechanical control or electrically by the activation of an electrical opening control.

The override lever 30 can have a beak that is configured to cooperate with an end of the central opening lever 10, such as the same end 10a of the central opening lever 10 protruding axially to cooperate with the end 17a of the inner release lever 17.

According to an embodiment, the paddle clutch 24 is moved by the locking lever 23 in the deployed position by the movement of the central opening lever 10 from the rest position to the active position to unlock the door latch 1 while the central opening lever 10 is driving the first lever 5 such that the door latch 1 is unlocked and released in the same movement of the central opening lever 10.

The override lever 30, especially the shape of its beak, may be conformed to move the locking lever 23 from the locked position to the unlocked position by the central opening lever 10 while the central opening lever 10 disengages the retention unit and release the door latch 1. Thus, unlocking and releasing occur in one same motion.

The override lever 30 can be driven from the unlocked position to the locked position with the movement of the locking lever 23 to the locked position activated by the locking motor 25.

In another embodiment not shown, the locking lever 23 may be driven directly (without intermediate override lever 30) from the locked position to the unlocked position by the movement of the central opening lever 10 from the rest position to the active position, thus by the central opening lever 10 intending to release the striker from the retention unit to release the door latch 1.

During inner opening mechanical release of a locked door latch 1 (from FIG. 4 to FIG. 5), the inner release lever 17 is moved in rotation by a user activating the inside handle from inside the vehicle. The rotation of the inner release lever 17 drives the central opening lever 10 in rotation to its active position. The pivoting of the central opening lever 10 pivots the override lever 30 which moves the locking lever 23 in the unlocked position deploying the paddle clutch 24 of the driver 4 so that a release is possible by the outer release lever 20. The door latch 1 is then unlocked. Moreover, the locking lever 23 may activate one or several switch(es) 35 that may send electrical unlocked signals to the control unit of the door latch 1 (FIG. 1). The activation of the switch may trigger an electrical assisting in moving the locking lever 23 from the locked position to the unlocked position, via the locking motor 25, accompanying the mechanical activation of the user pulling the inside handle.

In the meantime, the central opening lever 10 moves the first lever 5 of the driver 4 in rotation, which moves the pawl 3 from the claw 2 to disengage the pawl 3 from the claw 2 to release the door latch 1.

During inner opening mechanical release, the electrical gear wheel 13 is not moved or not significantly moved. Indeed, the electrical gear wheel 13 is disengaged from the central opening lever 10 when the central opening lever 10 is driven in rotation by the inner release lever 17 from its rest position to its active position.

After the inner opening mechanical releasing of the door, when the user releases the inside handle, the inner release lever 17 rotates back in the rest position. The override lever 30 and the locking lever 23 and thus the door latch 1 remain in the unlocked position.

During inner opening mechanical release of an unlocked door latch 1, steps are the same as for an initially locked door latch 1 except for the fact that the rotation of the central opening lever 10 does not pivot the override lever 30 which is already pivoted in the unlocked position, the paddle clutch 24 being engaged between the first and the second lever 5, 6 of the driver 4.

During an electrical release of a locked door latch 1 (from FIG. 4 to FIG. 6), a user activates an electrical opening control, which activates the releasing motor 11. The rotation of the output shaft 12 of the releasing motor 11 moves the electrical gear wheel 13 in rotation. This rotation engages the central opening lever 10 to rotate it to the active position.

Next steps are the same as during inner opening mechanical release: the pivoting of the central opening lever 10 pivots the override lever 30 which moves the locking lever 23 in the unlocked position deploying the paddle clutch 24 of the driver 4 so that a release is possible by the outer release lever 20. The door latch 1 is then unlocked. Moreover, the locking lever 23 may activate one or several switch(es) (not shown) that may send electrical unlocked signals to the control unit of the door latch 1.

In the meantime, the central opening lever 10 moves the first lever 5 of the driver 4 in rotation, which moves the pawl 3 to disengage the pawl 3 from the claw 2 to release the door latch 1.

During electrical release, the inner release lever 17 is not moved or not significantly moved. Indeed, the inner release lever 17 is disengaged from the central opening lever 10 when the central opening lever 10 is driven in rotation by the electrical gear wheel 13 from its rest position to its active position.

After the electrical releasing of the door, the control unit of the door latch 1 may control the releasing motor 11 to return in the rest position, driving back the electrical gear wheel 13. The releasing motor 11 rotates the electrical gear wheel 13 in the opposite direction, so the central opening lever 10 rotates back. The override lever 30 and the locking lever 23 and thus the door latch 1 remain in the unlocked position.

During an electrical release of an unlocked door latch 1, steps are the same as for an initially locked door latch 1 except for the fact that the rotation of the central opening lever 10 does not pivot the override lever 30 which is already pivoted in the unlocked position, the paddle clutch 24 being engaged between the first and the second lever 5, 6 of the driver 4.

Thus, the door latch 1 can be unlocked by the rotation of the inner release lever 17 intending to disengage the pawl 3 from the claw 2, i.e. by the user activating the inner mechanical control from inside the vehicle, and by the rotation of the electrical gear wheel 13 intending to disengage the pawl 3 from the claw 2, i.e. by the user activating an electrical opening control.

The door latch 1 thus comprises a mechanical kinematic chain transmitting the mechanical override function (unlocking the door latch 1) whatever is the origin of the release, mechanical from the inner side of the vehicle or electrical. Mechanical and electrical release kinematics work thus in parallel and are synchronized. If an electric unlock is done, the mechanical kinematic is unlocked too and in the other way, if a mechanical unlock from the inside of the vehicle is done, the electric kinematic is unlocked too. The user is therefore ensured to not be locked in and to not be locked out after inner mechanical opening and electrical opening.

This function is compliant with child lock mechanical kinematic.

FIGS. 7 to 11 show a second example of the door latch 1.

Only elements that differ from the first embodiment will be described below.

As in the first example, the locking lever 23 is configured to be moved from the locked position to the unlocked position by the movement of the central opening lever 10 driven in movement by the inner release lever 17 from the rest position to the active position and by the movement of the electrical gear wheel 13 from the rest position to the active position, the locking lever 23 remaining in the unlocked position after a releasing of the door latch 1.

In this embodiment, the central opening lever 10 is coaxial to the electrical gear wheel 13 driven by the releasing motor 11. However, in this example, the inner release lever 17 and the central opening lever 10 are not coaxial.

As better visible in FIG. 8, the inner release lever 17 pivots around an axis 31 that goes through the central opening lever 10.

According to an embodiment better visible in FIG. 9, the central opening lever 10 has a lug 32 that is moveable in a hole 33, for example in a shape of an arc, of the inner release lever 17. The lug 32 of the central opening lever 10 abuts a side of the hole 33 to be driven in movement by the inner release lever 17 when the inner release lever 17 is driven in movement from the rest position to the active position. The lug 32 of the central opening lever 10 moves in the hole 33, without (significantly) moving the inner release lever 17, when the central opening lever 10 is driven in rotation by the electrical wheel gear 13.

In this embodiment, the central opening lever 10 has a leg 34 configured to cooperate with the override lever 30, more specifically with the override lever 30's beak, to move the locking lever 23 from the locked position to the unlocked position.

Moreover, in this embodiment, the second lever 6 is configured to be driven by the movement of the central opening lever 10.

To rotate the second lever 6 of the driver 4, the tab 14 of the central opening lever 10 may cooperate with a pin 15 of the second lever 6 of the driver 4. Thus, when the central opening lever 10 rotates, the tab 14 pushes the pin 15, rotating the second lever 6.

Thus, the moving of the first lever 5 can only be driven by the movement of the second lever 6 driven by the outer release lever 20 or by the central opening lever 10 from the rest position to the active position via the paddle clutch 24 in the unlocked position of the locking lever 23.

Moreover, the paddle clutch 24 is configured to be driven in movement by the locking lever 23 in the deployed position by the movement of the central opening lever 10 from the rest position to the active position after the second lever 6 has been moved by the central opening lever 10 in a blocking position in which the second lever 6 blocks the movement of the paddle clutch 24 such that the paddle clutch 24 subjected to an elastic return force moves in the deployed position once the central opening lever 10 is released.

The override lever 30, especially the shape of its beak, may be conformed to drive the moving of the paddle clutch 24 in the deployed position after the second lever 6 has been moved by the central opening lever 10 in blocking position.

As in the first example, the locking motor 25 may also be configured to be moved from the locked position to the unlocked position with the movement of the locking lever 23 from the locked position to the unlocked position.

Unlocking occurs thus at the first inner opening mechanical release of a locked door latch 1 and releasing may occur at the second inner opening mechanical release (in two motions) or by an outer opening release or by an electrical release.

During inner opening mechanical release of a locked door latch 1 (from FIG. 7 to FIG. 10), the inner release lever 17 is moved in rotation by a user activating the inside handle from inside the vehicle.

The lug 32 of the central opening lever 10 abutting the hole 33 drives the central opening lever 10 in rotation.

The central opening lever 10 thus moves the second lever 6 of the driver 4 in rotation, but without driving the paddle clutch 24, and thus, without driving the first lever 5 in rotation, and therefore without releasing the door latch 1.

The pivoting of the central opening lever 10 pivots the override lever 30 via leg 34 which moves the locking lever 23 in the unlocked position. However, the second lever 6 has already be moved to face radially the paddle clutch 24, blocking the movement of the paddle clutch 24 in the deployed position. This compresses the paddle clutch 24's spring 28.

When the user releases the inner mechanical opening control, the inner release lever 17 rotates back in rest position releasing the central opening lever 10 and thus the second lever 6 which release the paddle clutch 24 in the deployed position (FIG. 11).

The door latch 1 is then unlocked.

The user may then release the door latch 1 by pulling a second time the inner mechanical opening control, moving the central opening lever 10 which moves the second lever 6 of the driver 4 in rotation, which moves the first lever 5 via the movement of the paddle clutch 24 which is deployed between the first lever 5 and the second lever 6, disengaging the pawl 3 from the claw 2 to release the door latch 1 (FIG. 12).

During inner opening mechanical release, the electrical gear wheel 13 is not moved or not significantly moved. Indeed, the electrical gear wheel 13 is disengaged from the central opening lever 10 when the central opening lever 10 is driven in rotation by the inner release lever 17 from its rest position to its active position.

During an electrical release of a locked door latch 1 (not represented), the user activates an electrical opening control, which activates the releasing motor 11. The rotation of the output shaft 12 of the releasing motor 11 moves the electrical gear wheel 13 in rotation. This rotation engages the central opening lever 10 to rotate it to the active position.

The lug 32 of the central opening lever 10 moves in the hole 33 of the inner release lever 17 without abutting the hole 33 and thus without driving the inner release lever 17. Thus, the inner release lever 17 is not moved or not significantly moved.

Next steps are the same as during inner opening mechanical release.

The central opening lever 10 moves the second lever 6 of the driver 4 in rotation, but without driving the paddle clutch 24, and thus, without driving the first lever 5 in rotation, and therefore without releasing the door latch 1.

The pivoting of the central opening lever 10 pivots the override lever 30 via leg 34 which moves the locking lever 23 in the unlocked position. However, the second lever 6 has already been moved to face radially the paddle clutch 24, blocking the movement of the paddle clutch 24 in the deployed position. This compresses the paddle clutch 24's spring 28.

The control unit of the door latch 1 then controls the releasing motor 11 to return in the rest position, driving back the electrical gear wheel 13. The releasing motor 11 rotates the electrical gear wheel 13 in the opposite direction, so the central opening lever 10 rotates back releasing the second lever 6 and thus the paddle clutch 24 in the deployed position.

The door latch 1 is then released as can be seen in FIG. 11.

The releasing motor 11 may be controlled by the control unit of the door latch 1 to be activated twice when a user activates an electrical (or electronical) opening control.

In a first time the releasing motor 11 moves the electrical gear wheel 13 from the rest position to the active position for unlocking the door latch 1 and after the releasing motor 11 has returned in the rest position driving back the electrical gear wheel 13, the releasing motor 11 can move a second time the electrical gear wheel 13 from the rest position to the active position for releasing the door latch 1.

According to the control unit programming, releasing may then occur after one or two pressing on the electrical opening control.

1-12. (canceled)

13. A door latch for closing a door of a vehicle, comprising:
a retention unit comprising a claw and a pawl, the retention unit is configured to engage with a striker of the vehicle in a closed position and release the striker to release the door latch in an open position;
an electrical gear wheel that is configured to be moved by a releasing motor from a rest position to an active position;
an inner release lever that is configured to be moved by an inner mechanical opening control from a rest position to an active position;
a central opening lever that is configured to be moved between a rest position and an active position, the central opening lever being driven in active position by the movement of the inner release lever from the rest position to the active position or by the electrical gear wheel from the rest position to the active position;
an outer release lever that is configured to be moved by an outer mechanical opening control from a rest position to an active position;
a locking lever that is configured to move between an unlocked position in which the movement of the outer release lever releases the retention unit of the door latch and a locked position in which the locking lever disengages the outer release lever from the retention unit,
wherein the locking lever is configured to be moved from the locked position to the unlocked position by the movement of the central opening lever driven in movement by the inner release lever from the rest position to the active position, and by the movement of the electrical gear wheel from the rest position to the active position, the locking lever remaining in the unlocked position after a releasing of the door latch.

14. The door latch according to claim 13, further comprising an override lever configured to move the locking lever from the locked position to the unlocked position and configured to be driven in movement by the central opening lever from the rest position to the active position.

15. The door latch according to claim 14, wherein the override lever is articulated to the locking lever.

16. The door latch according to claim 13, wherein the inner release lever, the central opening lever, and the electrical gear wheel are pivotally mounted on a same axis of the door latch.

17. The door latch according to claim 16, wherein the inner release lever and the central opening lever have a respective end which protrudes axially so that the end of the central opening lever is on a path of the end of the inner release lever in a direction of movement of the inner release lever to the active position.

18. The door latch according to claim 13, wherein the inner release lever pivots around an axis that goes through the central opening lever.

19. The door latch according to claim 18, wherein the central opening lever has a lug that is moveable in a hole of the inner release lever, the lug of the central opening lever abutting a side of the hole to be driven in movement by the inner release lever when the inner release lever is driven in movement to its active position, the lug of the central opening lever moving in the hole when the central opening lever is driven in rotation by the electrical gear wheel.

20. The door latch according to claim 13, further comprising a driver comprising a first lever configured to move the pawl in the open position, a second lever driven by the movement of the outer release lever and a paddle clutch configured to be moved by the locking lever in a deployed position between the first lever and the second lever of the driver such that, in the unlocked position of the locking lever, the movement of the second lever towards the active position drives the moving of the first lever to move the pawl in the open position to release the door latch and to be moved by the locking lever in a retracted position disengaging the paddle clutch from between the first lever and the second lever in the locked position of the locking lever.

21. The door latch according to claim 20, wherein the first lever is configured to be driven by the movement of the central opening lever and the paddle clutch is configured to be driven in movement by the locking lever in the deployed position while the central opening lever is driving the first lever such that the door latch is unlocked and released in the same movement of the central opening lever.

22. The door latch according to claim 20, wherein the second lever is configured to be driven by the movement of the central opening lever and the paddle clutch is configured to be driven in movement by the locking lever in the deployed position after the second lever has been moved by the central opening lever in a blocking position in which the second lever blocks the movement of the paddle clutch such that the paddle clutch subjected to an elastic return force moves in the deployed position once the central opening lever is released.

23. The door latch according to claim 13, further comprising a locking motor configured to move the locking lever from the unlocked position to the locked position, the locking motor being configured to be moved in the unlocked position with the movement of the locking lever from the locked position to the unlocked position.

24. A vehicle door, comprising:
an inner mechanical opening control;
an outer mechanical opening control;
the door latch according to claim 13,
wherein the inner mechanical opening control is mechanically linked to the inner release lever and the outer mechanical opening control is mechanically linked to the outer release lever.
